(19) United States
(12) Patent Application Publication
(10) Pub. No.: US 2003/0142324 A1
(43) Pub. Date: Jul. 31, 2003

(54) Optoelectronic measuring method and distance measuring device for carrying out the method

(76) Inventor: Rolf Beck, Esslingen (DE)

Correspondence Address: Friedrich Kueffner, Suite 910, 317 Madison Avenue, New York, NY, 10017, US

(21) Appl. No.: 10/376,122

(22) Filed: Feb. 28, 2003

Related U.S. Application Data
(63) Continuation of application No. 10/077,304, filed on Feb. 15, 2002.

(30) Foreign Application Priority Data
Aug. 28, 1996 (DE) 196 34 785.8

(51) Int. Cl. G01B 11/02

(52) U.S. Cl. 356/625

(57) ABSTRACT

An optoelectronic measuring method and a distance measuring device for carrying out the method for determining the dimensions with respect to length, width or height of objects mounted in or outside of processing or measuring machines. At least one ray bundle transmitted by a measuring head of a measuring device is projected on a surface of an object to be measured as a dot-shaped measuring spot at various locations on a circumferential line of a geometric figure, and the reflected ray bundle projects through a projection unit the respective measuring spot onto an optoelectronic transducer unit of the measuring head and the signals produced by the transducer unit are evaluated in an evaluating unit. The reflected ray bundle is deflected by the projection unit of the measuring head in such a way that the measuring spot projected on the optoelectronic transducer unit is independent of the position of rotation of the measuring spot projected onto the surface relative to the optical center axis of the measuring head.

### BACKGROUND OF THE INVENTION

1. Field of the Invention

The present invention relates to an optoelectronic measuring method and to a distance measuring device for carrying out the method. Specifically, the present invention relates to a method for determining the dimensions with respect to length, width or height of objects mounted in or outside of processing or measuring machines.

2. Description of the Related Art

Various optoelectronic methods and devices are known in the art for measuring objects. In these methods and devices, a distance measurement is carried out by producing a ray bundle from a radiation source by means of a structural focussing group (condenser), wherein, when impinging on the location to be examined (surface) of an object, the ray bundle projects on the object a dot-shaped measuring spot and the reflected measuring spot is projected by a projection unit onto an optoelectronic transducer unit of the measuring device, for example, a CCD line camera or CCD area camera, and the signals of the measuring device are evaluated; such a method is, for example, the triangulation method. Another method and a suitable device are described, for example, in DE 35 07 445 C 2.

In the methods described above, the transmitting unit as well as the receiving unit are in a fixed geometric relationship to the ray bundle. These methods are also called 1D methods (cf. DIN V 32936-1).

Also known in the art are solutions in which, for measuring surfaces and shapes or geometric shapes to be examined on the object, several dot-shaped measuring spots are successively or simultaneously projected and measured on a measuring length (straight measuring line), or several measuring lines located next to each other form a measuring area. Such methods are also called 2D methods or 3D methods.

These measuring lines or measuring areas are produced particularly either by deflecting the ray bundle, i.e., the measuring line or the measuring area is formed by a timed sequential sequence of individual measuring points, or by simultaneously illuminating the measuring locations by a so-called structured illumination.

All measuring methods and measuring devices mentioned above have independently of the basic 1D method a preferred direction with respect to a middle measuring ray direction because always at least approximately section-like measuring lines or a plurality thereof are used.

This disadvantage occurs especially in the case of moving devices as they are used on coordinate measuring machines or machine tools for evaluating larger components. This is because, in that case, the direction of movement of the device must be adapted to the preferred direction of the device in order to facilitate the intended use of the device. For example, a measuring line is moved preferably perpendicularly of its elongation because this makes it possible to measure the largest possible surface area, while a movement in the direction of the measuring line does not provide an advantage as compared to a 1D method. The disadvantage mentioned last is very often considered negligible because most of the 1D methods based on the 2D or 3D methods also already have a preferred direction.

### SUMMARY OF THE INVENTION

Therefore, it is the primary object of the present invention to provide a novel optoelectronic distance measuring method and a distance measuring device which at least minimize the disadvantages discussed above and are technically simpler and more economical and, moreover, make it possible to adapt to various measuring tasks.

In accordance with the present invention, in an optoelectronic distance measuring method of the above-described type, at least one ray bundle transmitted by a measuring head of a measuring device is projected on a surface of an object to be measured as a dot-shaped measuring spot at various locations on a circumferential line of a geometric figure, and the reflected ray bundle projects through a projection unit the respective measuring spot onto an optoelectronic transducer unit of the measuring head and the signals produced by the transducer unit are evaluated in an evaluating unit. The reflected ray bundle is deflected by the projection unit of the measuring head in such a way that the measuring spot projected on the optoelectronic transducer unit is independent of the position of rotation of the measuring spot projected onto the surface relative to the optical center axis of the measuring head.

The measuring spots projected at various locations are located on the circumferential line of a geometric figure which preferably is a circular line; this circumferential line may sometimes also be the circumferential line of a regular polygon or the like.

The present invention is preferably used so as to supplement optoelectronic measuring methods and devices whose basic 1D method is a method without preferred direction, particularly in connection with a distance measuring device according to DE 35 07 445 C2.

In accordance with a further development of the method according to the present invention, the evaluation computations are synchronously adapted to the respective measuring location, wherein, within the framework of a calibration for any position of rotation of the projected measuring spot, the function between distance and measuring signal is determined separately and the respective function is activated during the measuring operation in dependence on the position of rotation; the optical axes of all transmitted ray bundles may also be guided parallel to each other independently of the position of rotation referred to above.

A significant advantage of the present invention is that during the use in the moved measuring system, all directions of movement are treated equally and no influence of the direction of movement on the measuring result has to be expected.

Another significant advantage of the present invention is the fact that the optical components used for producing the scanned circumferential line, to be described below, are simple and inexpensive and that, even when used in a measuring system which does not move, a symmetrical measuring space is created.

Moreover, the distance measuring method according to the present invention has the advantage that it can be used for determining a surface inclination, the location of edges or the like, a mean distance value, gap widths and sight lines or contour lines.

For determining a surface inclination, the novel optoelectronic distance measuring method is carried out in such a way that the processing of the measuring value for determining the surface inclination is effected by computing a compensation plane through all measuring points of a scanned circumferential line, preferably a circular line, possibly after previously filtering for noise suppression in accordance with known methods; the computation is effected preferably in accordance with the method of the smallest error squares and the computation of the angle of inclination and the orientation of the compensation plane referred to above, preferably by indicating the angle between the perpendicular relative to the compensation plane and a mean ray bundle direction and the angle between an arbitrarily determined zero degree plane, which is fixed relative to the device and extends through the ray bundle direction, and the plane determined by this ray bundle direction and the perpendicular relative to the compensation plane.

It is advantageous in this connection that the determination of the inclination also takes place if only a portion of the scanned circumferential line produces valid measuring values.

In accordance with further developments, a quality function for the deviation of the individual measuring values relative to the computed compensation plane and the proportion of the invalid measured values is determined, or two or more partial ranges of the scanned circumferential line are used for a separate determination of the inclination.

For determining the distance of the location of edges or the like, for example, the inner or outer contour or the edge of an object, the present invention provides that the two points of intersection of a generated measuring circle with the edge is determined by evaluating the distance change on the measuring circle, a straight compensating line extending through these two points is computed and the distance of this straight line to the center axis of the measuring circle is computed as is the position of rotation of the straight line, i.e., the angle between an arbitrarily selected zero degree plane which is stationary relative to the device and extends through this center axis and the plane formed by this center axis and a parallel line to the straight compensating line extending through this center axis.

Which portion of the measuring circle is located on the object or the sign of the distance are determined by the smaller or valid distance value in this portion.

Another advantage in this connection is that the two points of intersection, possibly after filtering the individual measuring values per measuring circle, are determined by determining the two greatest local maxima of the distance change and/or that additionally the average distance is computed from the measuring values located on the object between the two determined points of intersection.

In addition, the inclination can be computed from the measuring values located on the object between the two determined points of intersection analogous to the determination of the surface inclination.

Moreover, it is possible to additionally determine the inclination of the straight compensating line, i.e., the angle between the center axis of the measuring circle (optical axis) and a line extending parallel to the perpendicular relative to the straight compensating line extending through this center axis of the measuring circle. Also, it is possible to lower the measuring uncertainty of the characteristic values of each generated measuring circle by a communication over several measuring circles, i.e., over several rotations of the individual measuring point on the measuring circle.

The specific method steps for determining the mean distance value are to form the average over several different measuring locations even when the device is not moved and, thus, to reduce not only the electrical, time-dependent noise, but also the optical noise which is dependent on the surface microreflections.

For the determination of gap widths using the novel optoelectronic distance measuring method, the determination of gap widths, particularly gaps which are smaller than the generated diameter of the measuring circle, is carried out by determining the four points of intersection of the measuring circle with the two edges of a gap by evaluating the distance change on the generated measuring circle, by computing two straight compensating lines through these four points and by computing the distance between the two lines.

Which sections of the circle line are located on the two structural components including the gap is determined by the smaller or valid distance values in these sections. The distance is preferably defined as that distance which is formed by the shortest connecting line through the center axis of the circle between the two planes formed from a parallel line to the center axis of the measuring circle through a respective straight compensating line and for the respective straight compensating line.

In accordance with a further development, the four points of intersection, possibly after filtering the individual measuring values per measuring circle, are determined by determining the four greatest local maxima of the distance change; in accordance with another development, additionally the parallelism of the gap width is computed. This parallelism is preferably defined by the angle between the two planes which are formed by a parallel line to the center axis of the measuring circle through a respective straight compensating line and by the respective straight compensating line.

In accordance with further advantageous embodiments, the gap width can be determined as follows. The gap misalignment relative to the center axis of the measuring circle is computed. Preferably, the gap misalignment is determined by the distance of the bisecting line of the angle between the two straight compensating lines from the center axis of the measuring circle. In addition, the gap orientation can be computed. Preferably, the gap orientation is defined as an angle between an arbitrarily determined zero degree plane which is stationary relative to the device and extends through the center axis of the measuring plane and the plane which is formed by this center axis and a parallel plane to the angle bisecting line through this center axis. On the other hand, on both sides of the gap the average distance is computed as the mean value of the measuring values located on the respective object between the two determined points of intersection. In addition, the two inclinations are computed, analogously to the surface inclination determination, from the measuring values located on the two objects between the two determined points of intersection.

Also, the vertical offset of the two edges of the gap is determined in the area of the measuring circle diameter. The vertical offset is preferably determined as the difference between the two mean distance values determined in accordance with the steps described above. The computation of the vertical offset can also be related to one of the two compensating planes through the measuring values located on the two objects between the two determined points of intersection, or, in accordance with an equally valid feature, through a mean plane determined by the two planes, i.e., on a plane extending perpendicularly to the angle bisecting plane of the two planes. Even when the device is inclined, this makes it possible to determine a vertical offset which is in relation to the object and independent of the orientation of the device.

The vertical offset if preferably computed from the distance of the center point of one of the two lines through the point of intersection and the compensating plane through the measuring points on the respectively other structural component or, if the mean plane is selected as the reference plane, through the difference of the distances of the two center points of the two lines relative to this plane.

In addition, it is possible to compute the vertical offset pattern of the two edges of the gap. Preferably, the vertical offset pattern is defined as the angle between the two straight lines which result as the lines of intersection of the plane through the angle dissecting line of the two lines and the center axis of the measuring circle and by the two compensating planes on the two objects.

Moreover, the measuring uncertainty of the characteristic values determined per measuring circle can be reduced by forming the average over several measuring circles, i.e., for measuring methods with several rotations of the individual measuring point on the measuring circle.

For determining sight lines or contour lines, the optoelectronic distance measuring method according to the present invention provides recognizing predefined distance change patterns whose axis of symmetry and spatial location relative to the measuring circle center axis are computed, wherein preferably, instead of predefined distance change patterns, general pattern recognizing functions can be used for recognizing sight lines and contour lines. This pattern recognizing function preferably is the determination of local maxima or minima, wherein line patterns are recognized by a suitable allocation.

In addition, a measuring value processing can be carried out with respect to a tape value determination.

The various features of novelty which characterize the invention are pointed out with particularity in the claims annexed to and forming a part of the disclosure. For a better understanding of the invention, its operating advantages, specific objects attained by its use, reference should be had to the drawing and descriptive matter in which there are illustrated and described preferred embodiments of the invention

### BRIEF DESCRIPTION OF THE DRAWING

In the drawing:

FIG. 1 is a schematic illustration of the distance measuring device according to the present invention, wherein the transmitted ray bundle meets the object deflected parallel to the optical axis of the measuring head;

FIG. 2 is a top view of the object to which the ray bundle is transmitted, showing a generated measuring field with scanned circle line;

FIG. 3 is a bottom view into the measuring head with a circular line-shaped arrangement of several dot-shaped radiation sources;

FIG. 4 is a bottom view into the measuring head with the arrangement of several dot-shaped radiation sources over a surface area; and

FIG. 4a is a partial side view of the measuring head of FIGS. 3 and 4.

### DETAILED DESCRIPTION OF THE PREFERRED EMBODIMENTS

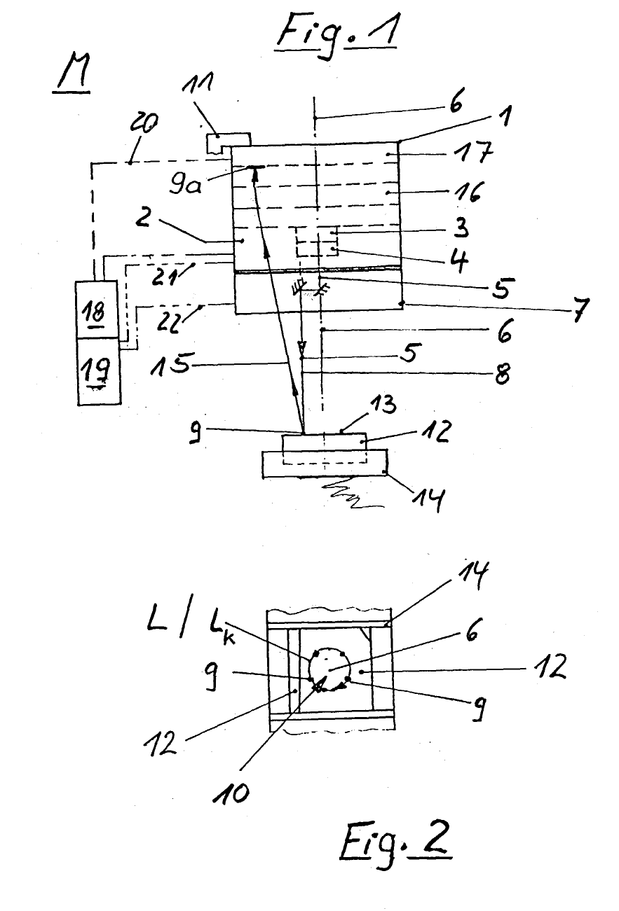

FIG. 1 of the drawing shows a preferred embodiment of an optoelectronic distance measuring device M according to the present invention for carrying out the optoelectronic distance measuring method according to the present invention.

FIG. 1 of the drawing shows a conventional measuring head 1 mounted in a frame 11. The measuring head 1 includes at least one illumination unit 2 with a radiation source 3 and a condenser 4 as well as a reproduction unit 16 with an optoelectronic transducer unit 17 arranged following the reproduction unit 16. In addition, the measuring head 1 or parts thereof are connected through signal pulse lines or control pulse lines 20, 21, 22 to an evaluating unit 18 and a control unit 19; in a special embodiment, if required, at least parts of the evaluating unit 18 and/or the control unit 19 may be arranged directly in the measuring head.

The important feature with respect to the device and the method according to the present invention is the fact that the transmitted ray bundle 5 is projected as a measuring spot 9 on the surface 13 of the illustrated object 12 to be measured along the circumferential line L of a predeterminable geometric FIG. 5, specifically a circle line L_{K}, as is particularly clear from FIG. 2. The scanned circumferential line L is preferably not limited to the circle line L_{K}, but may also be the circumferential line of a regular polygon, an equilateral triangle, a square or other geometric figures. The shape of the circumferential line to be scanned depends essentially on the measuring task to be performed.

In accordance with a preferred development, a deflection unit 7 is mounted on the measuring head 1 on the side of the object, wherein the deflection unit 7 is constructed in such a way that the transmitted ray bundle 5 is deflected from the optical axis 6 into a second optical axis 8 extending parallel to the optical axis 6, and wherein the second optical axis 8 is optionally rotatable about the optical axis 6; preferably, the rotation of the second optical axis 8 about the optical axis 6 takes place continuously.

The reflected ray bundle 15 emanating from the dot-shaped measuring spot 9 projected sequentially at various locations is reproduced through a reproduction unit 16 on an optoelectronic transducer unit 17 of the measuring head 1 at 9a. The signals 20 produced by the transducer unit 17 are then evaluated in an evaluating unit 18.

Another and especially important feature is that fact that the reflected ray bundle 15 is deflected from the reproduction unit 16 of the measuring head 1 in such a way that the measuring spot 9a projected on the optoelectronic transducer unit is independent of the position of rotation of the measuring spot 9 projected onto the surface 13 relative to the optical center axis 6 of the measuring head 1. Consequently, reproduction errors which are due to the system, particularly in the case of measurements according to the triangulation principle, are substantially minimized or eliminated.

In accordance with additional further developments according to the present invention, the means provided in the measuring head 1 for projecting the transmitted ray bundle 5 and the means for reproducing the reflected ray bundle 15 are at least partially one and the same optical parts or structural groups, wherein these parts or structural groups are additionally mounted so as to be adjustable; in addition or alternatively, the means for projecting and the means for reproducing each include at least one planar parallel plate.

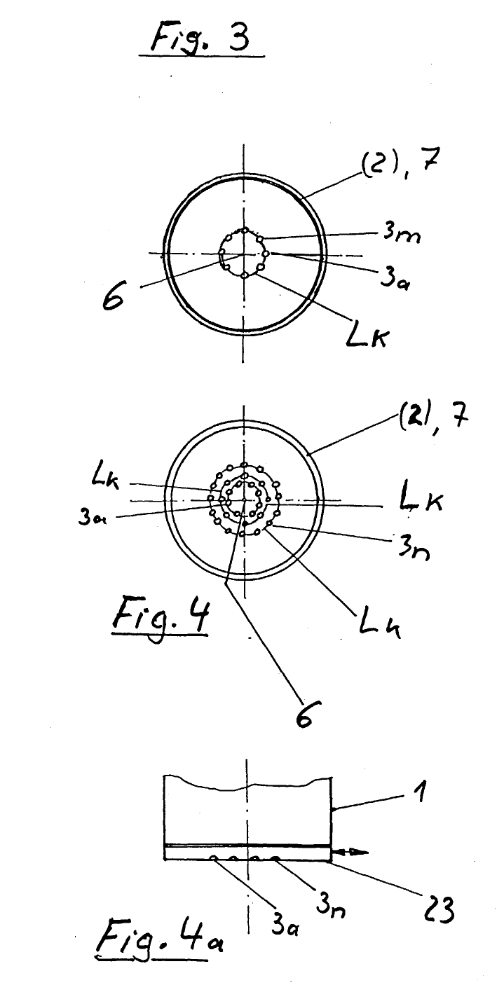

Additional further developments of the invention are the embodiments shown in FIGS. 3, 4 and 4a.

FIG. 3 shows an embodiment in which several dot-shaped radiation sources 3a . . . , 3n are provided in the measuring head 1, wherein the radiation sources are arranged distributed over a surface area and can be operated optionally, and wherein the radiation sources are located preferably in accordance with the respectively selected circumferential line L to be scanned, i.e., the circle L_{K}, in the illustrated embodiment.

In the embodiment of FIG. 4, of the plurality of dot-shaped radiation sources 3a . . . , 3n arranged distributed over a surface area in the measuring head 1 in accordance with the selected circumferential line or lines to be scanned, the respective radiation sources are preferably operated sequentially over time.

In the embodiment of the device according to the present invention shown in FIGS. 3 and 4, there is the additional possibility that, of the plurality of dot-shaped radiation sources 3a . . . , 3n, several or all radiation sources 3a . . . , 3n are in operation simultaneously and that, in accordance with the selectable circumferential line, a specific modulation is allocated for the radiation sources 3a . . . 3n which are in operation.

In accordance with another significant feature of the present invention, the scanned circumferential line L is produced by moving the support 14 holding the object 12.

In practical use, the novel optoelectronic distance measuring method and the optoelectronic distance measuring device, as well as the method steps according to the present invention for the fields of use described above, produce improved measuring qualities.

The invention is not limited by the embodiments described above which are presented as examples only but can be modified in various ways within the scope of protection defined by the appended patent claims.

I claim:

1. In an optoelectronic distance measuring method including projecting at least one ray bundle transmitted by a measuring head of a measuring device on a surface of an object to be measured as a dot-shaped measuring spot at various locations on a circumferential line of a geometric figure, wherein the reflected ray bundle projects through a projection unit the respective measuring spot onto an optoelectronic transducer unit of the measuring head, and evaluating signals produced by the optoelectronic transducer unit in an evaluating unit, the improvement comprising deflecting the reflected ray bundle by the projection unit of the measuring head in such a way that the measuring spot projected on the optoelectronic transducer unit is independent of a position of rotation of the measuring spot projected onto the surface relative to an optical center axis of the measuring head.

2. The method according to claim 1, comprising synchronously adapting the evaluation computations to the measuring location, wherein, within a framework of a calibration for any position of rotation of the projected measuring spot, a function between distance and measuring signal is determined separately and the function is activated during the measuring operation in dependence on the position of rotation.

3. The method according to claim 2, wherein the optical axes of all transmitted ray bundles extend parallel to each other independently of the position of rotation.

4. The method according to claim 1, wherein the method is used for determining a surface inclination, further comprising carrying out a measured value processing for determining the surface inclination by computing a compensation plane through all points of a measured circumferential line, and computing an angle of inclination and an orientation of the compensation plane.

5. The method according to claim 1, wherein the method is used for determining a mean distance value, comprising scanning the circumferential line and carrying out a measured value processing for determining the mean distance through the scanned circumferential line.

6. The method according to claim 1, wherein the method is used for determining locations of edges or the like, comprising carrying out a measured value processing in such a way that the circumferential line is scanned, points of intersection of the scanned circumferential line with a scanned contour are determined by evaluating a distance change on a circle line, computing a straight compensation line through the points of intersection, and computing a distance of the straight compensation line to the center axis of the measuring circle formed by the circle line and computing the position of rotation of the measuring circle.

7. The method according to claim 1, wherein the method is used for determining gap widths, wherein the gap widths are smaller than a diameter of measuring circles, comprising carrying out a measured value processing in such a way that four points of intersection of the measuring circle with two edges of a gap are determined by evaluating a distance change on the generated measuring circle, by computing two straight compensation lines through the four points of intersection and computing the distance between the two straight compensation lines.

8. The method according to claim 1, wherein the method is used for determining sight lines or contour lines on an object, comprising carrying out a measured value processing in such a way that predefined distance changing patterns are recognized, an axis of symmetry of the patterns and a spatial position relative to a center axis of the scanned geometric figure are computed.

9. A distance measuring device for carrying out an optoelectronic distance measuring method, the device comprising a frame and at least one measuring head, and at least one evaluating unit and a control unit connected to one another through signal lines, wherein the measuring head comprises means for producing, transmitting and projecting at least one ray bundle along a circumferential line of a predeterminable geometric figure on an object, and means for reproducing the ray bundle reflected by the object on at least one optoelectronic transducer unit, wherein the means for projecting the transmitted ray bundle along the circumferential line of the predeterminable figure and the means for reproducing the reflected ray bundle on the optoelectronic transducer unit are configured such that system-inherent reproduction errors are essentially minimized or eliminated.

10. The device according to claim 9, wherein the means for projecting the transmitted ray bundle along the circumferential line of the predeterminable and the means for reproducing the reflected ray bundle on the optoelectronic transducer unit are selected so as to essentially eliminate system-inherent reproduction errors in measurements according to the triangulation principle.

11. The device according to claim 9, wherein the means for projecting and the means for reproducing each comprise at least one planar parallel plate.

12. The device according to claim 9, wherein the means for projecting the transmitted ray bundle and the means for projecting the reflected ray bundle are at least partially comprised of a single optical part or structural component.

13. The device according to claim 12, comprising means for adjusting the optical parts or components.
